(19) United States
(12) Patent Application Publication
(10) Pub. No.: US 2015/0240748 A1
(43) Pub. Date: Aug. 27, 2015

(54) ASSEMBLY FOR BUFFERING A LIQUEFIED PETROLEUM GAS IN A LIQUEFIED PETROLEUM GAS STORAGE AND STORAGE BAG THEREFORE

(71) Applicant: Vialle Alternative Fuel Systems B.V., Eindhoven (NL)

(72) Inventor: Servatius Alfons Maria Jaasma, Eindhoven (NL)

(21) Appl. No.: 14/421,116

(22) PCT Filed: Aug. 16, 2013
(86) PCT No.: PCT/EP2013/067185

§ 371 Date: Feb. 11, 2015

(30) Foreign Application Priority Data
Aug. 16, 2012 (NL) 2009328

(51) Int. Cl. F02M 21/02; F02M 59/44; F17C 1/00

(52) U.S. Cl. CPC F02M 21/0212; F17C 1/00; F02M 59/44

(57) ABSTRACT

The invention relates to a storage bag for temporarily accommodating the liquefied petroleum gas, to a liquefied petroleum gas storage, to a fuel supply system, and to an assembly for buffering a liquefied petroleum gas (LPG) in a liquefied petroleum gas storage. The storage bag is arranged for temporarily accommodating the liquefied petroleum gas, having a fuel collection volume and a supply unit for allowing liquefied petroleum gas from the storage to enter into the fuel collection volume. The assembly can comprise a fuel pump having a pump housing and an inlet connected to the fuel collection volume. According to the invention a fuel pump and storage bag connection is arranged to allow feeding of the assembly the one after the other through an opening of the liquefied petroleum gas storage. According to the invention the storage bag comprises a jet pump.

The invention relates to an assembly for buffering a liquefied petroleum gas (LPG) in a liquefied petroleum gas storage tank comprising a storage bag for temporarily accommodating the liquefied petroleum gas and a fuel pump for liquefied petroleum gas. Further the invention relates to a storage bag for temporarily accommodating the liquefied petroleum gas. The invention also relates to an assembly for supplying LPG to a LPG fuel system.

Temporary accommodating or buffering of a liquefied petroleum gas is known from e.g. WO 2010/123366 in the name of the same applicant explicitly incorporated in its entirety by reference.

In order to continuously supply a liquefied petroleum gas to an engine, liquefied petroleum gas held in a LPG storage tank is buffered in a storage bag. The storage bag is connected to the inlet of a LPG fuel pump. The LPG fuel pump can supply the LPG fuel to the LPG fuel system and subsequently to the engine. The storage bag will accommodate a limited volume of fuel around a discharge to or inlet of the fuel pump.

The storage bag is received in the LPG storage tank. The LPG storage tank is a pressure container. To withstand high pressures these tanks should have simple, rounded shapes resulting in a reduced amount of welds. The LPG storage tank has an opening of limited size, which will limit the size of the storage bag or other parts that are to be received in the LPG storage. The storage bag is inserted through an opening of the LPG storage tank. In some embodiment the LPG fuel pump is also inserted through the opening. Any additional adaptation to the tank to insert the pump and storage bag assembly into the LPG storage tank would result in high costs.

In WO2010/123366 the LPG pump is held inside the storage bag. In WO2010/123366 the storage bag is deformed, while held around the fuel pump. The storage bag and fuel pump are inserted through the opening together and the storage bag regains it default form after insertion. The LPG fuel pump is inserted into the LPG storage tank to secure feeding liquid LPG to the LPG fuel pump.

It is a goal to further improve the known assembly. In an example it is a goal to ease insertion. In an example it is a goal to improve the storage bag, in particular the collection and/or buffering the liquid LPG.

According to a first aspect an assembly of fuel pump and storage bag can inserted into the liquefied petroleum gas storage tank through an opening of the LPG storage tank. The assembly for buffering a liquefied petroleum gas (LPG) in a liquefied petroleum gas storage tank can comprise:
a storage bag for temporarily accommodating the liquefied petroleum gas having a fuel collection volume and a supply unit for allowing liquid fuel from the storage tank into the fuel collection volume and
a LPG fuel pump having a pump housing and an inlet. A connection between the LPG fuel pump and the storage bag allows supply of buffered LPG from the storage bag to the inlet. The collection volume is arranged to prevent vapour LPG from entering the fuel pump inlet. Only liquid LPG is subsequently fed into the fuel supply system and engine.

In an embodiment the connection between the fuel pump and the storage bag is arranged to allow feeding of the assembly through an opening of the liquefied petroleum gas storage tank the one part after the other. The one part after the other refers to either inserting the storage bag first and subsequently the fuel pump, or the other way around. By subsequently feeding the assembly parts of fuel pump and storage bag into the LPG storage tank, the fuel pump and storage bag can be fed into the storage through the opening of limited size of the storage tank. The storage bag and/or the fuel pump can have an increased diameter over the prior art arrangements when inserted through the same opening.

Contrary to WO2010/123366 the invention allows subsequent insertion of the storage bag and fuel pump through the opening of the LPG storage tank, wherein the storage bag is not held or wrapped around the fuel pump during insertion. The one-after-another insertion allows insertion of a bigger fuel pump or a larger storage bag. EP 2 035 684, U.S. Pat. No. 6,192,918 and US 2004/182452 are other examples of LPG buffering in the storage tank. None of the prior art allow increasing the size of the fuel pump during insertion.

In an embodiment the connection allows relative movement of the storage bag with respect to the fuel pump. The connection can have a deformed state that allows the insertion of the storage bag and fuel pump the one after the other. In such an embodiment the storage bag can be rigid. The LPG fuel pump and the storage bag can be inserted without deformation of the respective parts.

In another embodiment the connection is a rigid connection.

In an embodiment deformation of the storage bag allows feeding of the storage bag and fuel pump the one after the other through the opening.

The connection between the fuel pump and storage bag can be a separate part or can be an integral part of either the storage bag or the fuel pump.

In an embodiment the assembly is arranged to feed the storage bag into the opening before the fuel pump. In another embodiment the fuel pump is inserted first. The fuel pump can be connected to further downstream elements by fuel lines, while the storage bag is generally the most upstream part of the fuel supply system.

In an embodiment the storage bag can comprise an elongated e.g. cylindrical bag.

In an embodiment the connection between the fuel pump and the storage bag is biased to hold the storage bag in a default position with respect to the fuel pump. From a deformed state of the storage bag and/or a deformed state of the connection during insertion the assembly is biased to the default state that allows the operation of the storage bag and fuel pump. The bias in the connection allows arranging the assembly in a default position inside the LPG storage tank, whereas during insertion the connection allows a different arrangement, e.g. an elongated arrangement. During insertion the deformed state is temporarily held, allowing insertion of the storage bag and fuel pump the-one-after-the-other, where after the default state is adopted.

In an embodiment the default position is different from the insertion state when the assembly is inserted into the opening of the LPG storage tank. In an embodiment the pump housing and storage bag extend adjacently in first default condition. In an embodiment the most upstream part of the storage bag is hinged toward the fuel body.

In an embodiment the assembly has a temporary second condition wherein the pump housing and storage bag extend generally in line with one another. The storage bag and pump are inserted through the opening in the second temporary condition and take on the default position after insertion.

In prior art arrangements inserting the assembly into the LPG storage tank focused on reducing the volume of the storage bag, whereas according to an aspect this invention is directed at using the length of the inserted assembly. Parts of the assembly are inserted through an opening one after the other.

In a further embodiment the connection between the storage bag and fuel pump comprises a hinge. The hinge will allow moving the storage bag and pump housing with respect to each other. The biased hinge will allow moving the storage bag and fuel pump back into the default position after insertion.

In an embodiment the assembly further comprises a accessory plate or cap to be mounted in the opening of the liquefied petroleum gas storage tank, wherein the accessory plate or cap is connected to the storage bag such that the storage bag is mounted on or near the bottom of the liquefied petroleum gas storage tank. This will ensure feeding liquefied petroleum gas to the storage bag, even if not much liquid fuel is left in the storage tank.

In this application a bottom of the liquefied petroleum gas storage tank is preferably a lowest part of the tank where any remaining fuel (in a non accelerated state) of the fuel storage will collect.

In an embodiment the fuel pump is connected to the accessory plate or cap such that the fuel pump is mounted near or on the bottom of the LPG storage tank. Also in this embodiment the inlet of the fuel pump in positioned near a bottom of the LPG storage tank. This will further ensure that liquid fuel is available at the inlet of the pump. This will prevent gas bubbles from being fed into the fuel system and to the engine.

In an embodiment a fuel supply line and at least one electric line connects the fuel pump and cap. The fuel supply line will allow this feeding fuel from the storage tank through the cap into a fuel system of an engine and the electric line will provide electrical power to the fuel pump.

In an embodiment storage bag is formed from deformable memory material. This allows deforming the storage bag e.g. when inserting and the storage bag will regain its defaults condition after deformation. In an embodiment rubber is used. In another embodiment the storage bag is formed using a plastic.

In an embodiment the storage bag has a default shape and is deformed to be fed through the opening of the storage tank, wherein the default shape is larger than the opening. This will allow feeding a storage bag through an opening that is smaller than the minimum cross-sectional area of the storage bag in operational condition. The default shape will allow collecting more fuel to be held as buffered volume.

In an embodiment the supply unit comprises a pump and fuel pre-collection volume having a liquefied petroleum gas inlet, wherein a partition wall is arranged to allow overflowing of the liquefied petroleum gas from the pre-collection volume into the collection volume. If sufficient fuel is pumped into the pre-collection volume, the volume will overflow the partition wall and enter the collection volume that is connected to the inlet of the fuel pump.

In an embodiment the supply unit can comprise an inlet valve such as a one direction valve to allow liquefied petroleum gas to enter the storage bag and prevent the entered fuel from flowing back to the storage tank.

In an embodiment the supply unit comprises a jet pump. The jet pump is arranged to supply fuel into the storage bag. In an embodiment the jet pump feeds fuel to the collection volume. The jet pump will allow collecting a level of fuel in the collection volume that is more than the level of an almost empty storage tank.

In an embodiment the jet pump feeds fuel into the pre-collection volume and is arranged to pump the fuel in order to flow over the partition wall.

The jet pump inserted in the fuel storage is free from mechanical elements and has a high reliability. Further such a fuel jet pump can have a high capacity wherein the volume of motive fluid is about 10% of the pumped total volume.

In an embodiment of an assembly of storage bag, fuel pump and connection, a fuel line connects the cap with a motive fluid inlet of the jet pump. In this embodiment the motive fluid used in the jet pump is provided from outside the LPG storage tank. The fuel from outside is fed to the jet pump through a fuel line from the cap to the motive fluid inlet.

According to a further aspect the liquefied petroleum gas storage with an opening is provided in combination with an assembly having one of the above for other features described in this application.

According to another aspect a fuel supply system for liquefied petroleum gas is provided. According to this aspect the liquefied petroleum gas storage tank comprising an opening and having assembly is inserted into said liquefied petroleum gas storage tank. The assembly can be any of the embodiments according to this application. The assembly is connected with the fuel supply system. In an embodiment a fuel line connects the fuel pump inserted in the LPG storage tank with an engine.

In a further embodiment a fuel return line is connected from the engine to a motive fluid inlet of a jet pump that is a part of the supply unit.

According to still a further aspect of the invention a storage bag for temporarily accommodating a liquefied petroleum gas for liquefied petroleum gas storage tank comprises a jet pump. Such a storage bag can comprise any of the features implicitly or explicitly disclosed in this application.

According to this aspect the fuel pump can be positioned outside the LPG storage tank. The jet pump feeds liquid LPG from the LPG storage bag that buffers liquid LPG to the fuel pump that is held outside the LPG storage tank. Even though a jet pump can build up only a small pressure, such a pumping pressure is enough to provide fuel from inside the LPG storage tank over a connection to an outside positioned fuel pump.

In an embodiment a motive fluid for the jet pump is supplied form the LPG fuel tank provided outside the LPG storage tank. The motive fluid is formed by liquid LPG provided from the fuel pump. In an embodiment a return line from the LPG fuel system provides the motive fluid for the jet pump.

The LPG storage can be ring-shaped or toriodal, specifically a ring torus. The fuel pump that is connected with an inlet to the storage bag, can be positioned in the centre of the ring torus.

In an embodiment the fuel pump is located lower than the storage bag.

According to yet a further aspect a fuel supply system is provided wherein a fuel return line from an engine is connected to a motive fluid inlet of a jet pump of a storage bag for LPG. The storage bag is received in a liquefied petroleum gas storage tank. The fuel supply system is a liquefied petroleum gas supply system. The storage bag collects LPG for feeding to an inlet of a LPG fuel pump. The jet pump is received in the liquefied petroleum gas storage tank.

In an embodiment the return fuel is used to propel LPG from the LPG storage tank into the storage bag. In order to have enough motive fuel for the jet pump, in an embodiment the return line fuel feeds fuel under pressure, e.g. at least 2 bar more than the prevailing vapour pressure inside the LPG storage tank. Under normal circumstances the pressure in the LPG storage tank is about 8 bar.

According to this aspect the fuel pump can be positioned outside the LPG storage tank. The jet pump is part of connection between the collection volume of the storage bag and the inlet of the external fuel pump. The jet pump propels LPG from the storage bag to the fuel pump. Even though a jet pump can build up only a small pressure, such a pumping pressure is enough to provide fuel from insdie the LPG storage tank over a connection to an outside positioned fuel pump.

In an embodiment the LPG storage tank can be ring-shaped or toriodal, specifically a ring torus. The fuel pump is connected with an inlet to the storage bag can be positioned in the centre of the ring torus. In an embodiment the fuel pump is located lower than the storage bag.

According to yet a further aspect the invention relates to a storage bag for temporarily accommodating a liquefied petroleum gas in liquefied petroleum gas storage tank. According to this aspect the storage bag has a fuel collection volume and a supply unit for feeding LPG from the liquefied petroleum gas storage tank into the fuel collection volume. The fuel collection volume buffers LPG in order to prevent vapour/gas from entering an inlet of a LPG fuel pump connected to the LPG collection volume.

In an embodiment the fuel collection volume is free of any mechanically switching elements for feeding fuel from the storage bag into the collection volume.

In an embodiment the supply unit comprises a fuel pre-collection volume having a liquefied petroleum gas inlet. In an embodiment a partition wall is arranged to allow overflowing of the liquefied petroleum gas from the pre-collection volume to the collection volume. Accordingly the storage bag, received in the LPG storage tank, collects and buffers the liquefied petroleum gas in two steps. The collection volume buffers the fuel. Fuel is fed to the collection volume by feeding the fuel over the partition wall from the pre-collection volume the collection volume.

Accordingly the liquefied petroleum gas is collected in secure manner around an outlet connectable to or the inlet of the fuel pump. Fuel collected in the collection volume will remain in that volume for long periods, even when the engine is not running. This will secure liquid fuel at the entrance of the fuel pump for long periods and/or if the engine is not running.

In an embodiment the supply unit of the storage bag comprises a jet pump. The jet pump is a long lasting, reliable and efficient pumping mechanism, free from any mechanically switching elements. The jet pump will be arranged to pump fuel into the pre-collection volume in order to overflow the partition wall and collect the fuel in collection volume.

In a further embodiment the storage bag is formed from a deformable memory material. Plastic can be used. A rubber can be used.

In an embodiment the jet pump is sealed into the material of the storage bag. Preferably the jet pump is arranged near a bottom end of the storage bag. In an embodiment an entry of the jet pump is arranged near a bottom end.

In a further embodiment the storage bag has a deformed state of a temporarily, size-reduced condition wherein an outer diameter of the storage bag is less than a predetermined size, and a second, operative or default condition in which the storage bag has a volume, with an outer diameter greater than the predetermined size. The predetermined size can be the cross section of an opening of a LPG storage tank in which the storage bag is mounted.

According to still a further embodiment a jet pump is provided in a LPG storage tank connected to a LPG fuel pump mounted outside the LPG storage tank. A jet supply line for the jet motive fluid is connected to a LPG fuel supply located outside the LPG storage tank. A suction line of the jet pump received liquid LPG from within the LPG storage tank. The jet pump is connected to an inlet of the externally positioned LPG fuel pump. Such a set up allows positioning only a relatively small jet pump inside the LPG storage tank that provides liquid fuel to the LPG fuel pump mounted outside. The problem of inserting the LPG pump into the LPG storage tank is thereby overcome.

In an embodiment the liquid LPG is held or buffered in a storage bag and the suction line of the jet pump is connected to the storage bag. The storage bag can be provided with a one way valve or a further jet pump to collect and buffer liquid LPG in the collection volume.

According to still another aspect a method of mounting a LPG storage bag for buffering liquid LPG and LPG fuel pump in a LPG storage tank is provided. The method comprises feeding the storage bag and fuel pump the one after the other through an opening of the LPG storage tank. This allows feeding a fuel pump of maximum circumference through the opening, while subsequently the storage bag for buffering is inserted.

The storage bag and fuel pump are connected. The method can comprise deforming the connection and/or deforming the storage bag during insertion of the assembly of storage bag and fuel pump into the opening.

In an embodiment the method further comprises baising the storage bag and/or the connection, preferably resiliently, to a default position. In the default position the storage bag and fuel pump are held operationally, e.g. held upright, in the LPG storage tank.

The invention will be described in greater detail with reference to the appended drawings showing further embodiments. However, it will be clear to the person skilled in the art that a broad range of embodiments are possible within the scope of the invention. It will also be clear to the person skilled in the art that various features as mentioned in this description may be combined with another unless this is explicitly ruled out. This description includes the explicitly but also the implicitly mentioned advantages of the features specified in the present document. In the drawings:

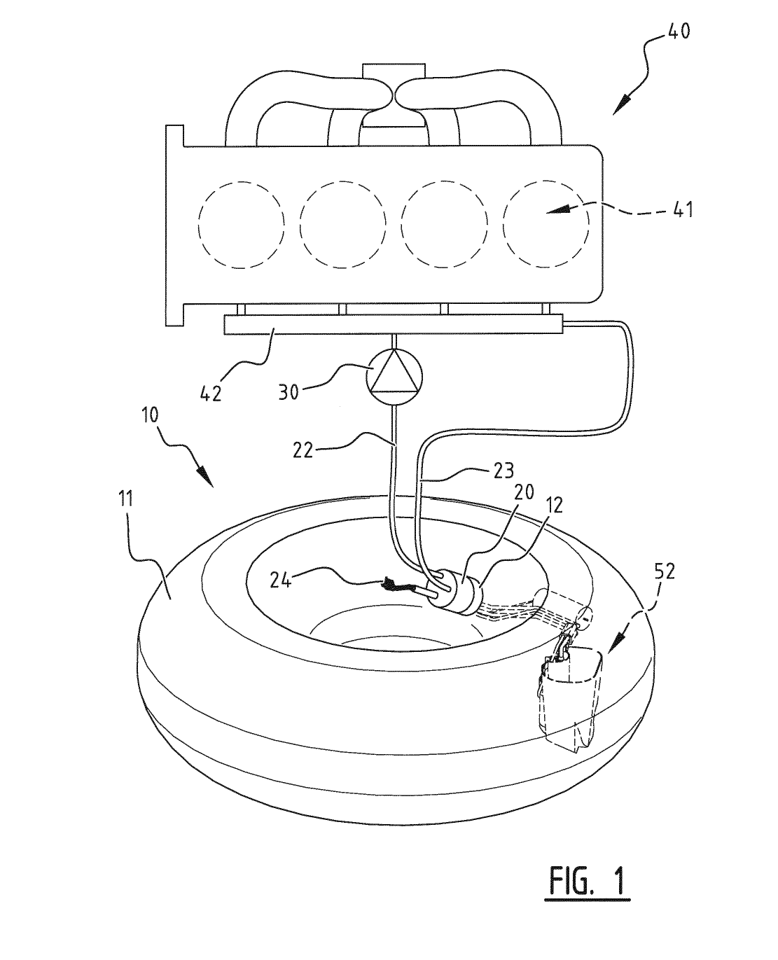

FIG. 1 is a schematic, partly exploded view of a fuel supply system according to a first embodiment;

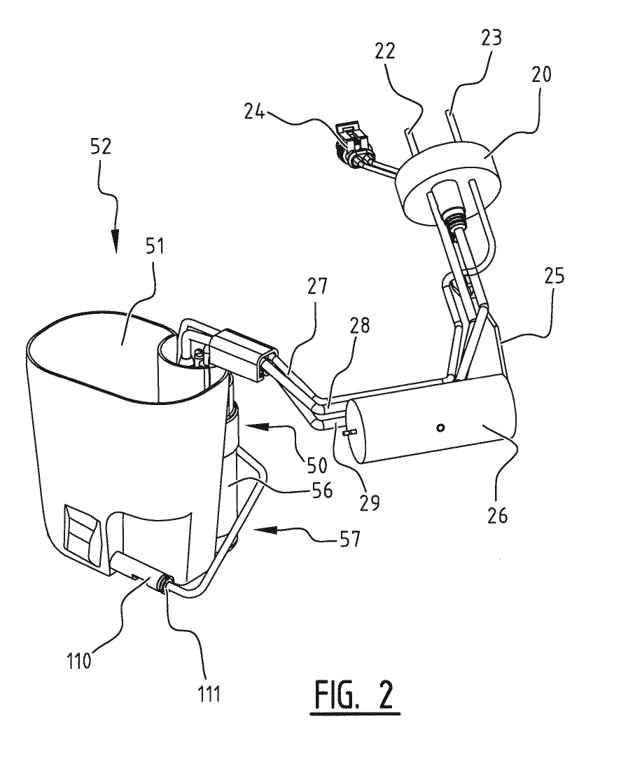

FIG. 2 is a view of an assembly according to an embodiment; and

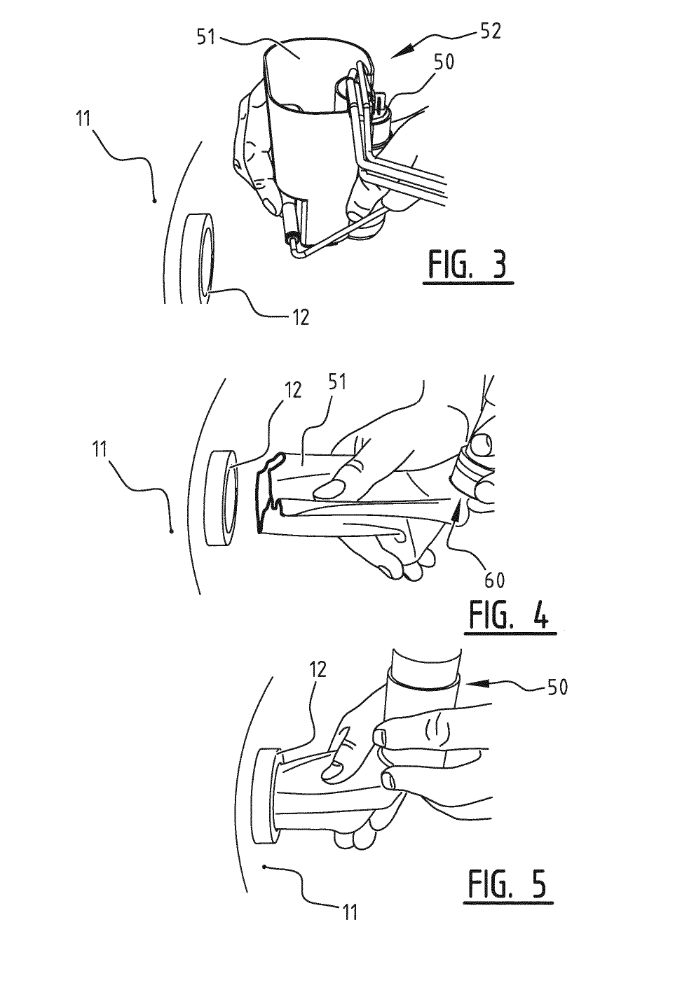

FIGS. 3-5 illustrate schematically the insertion of an embodiment of the assembly through an opening of a liquefied petroleum gas storage tank;

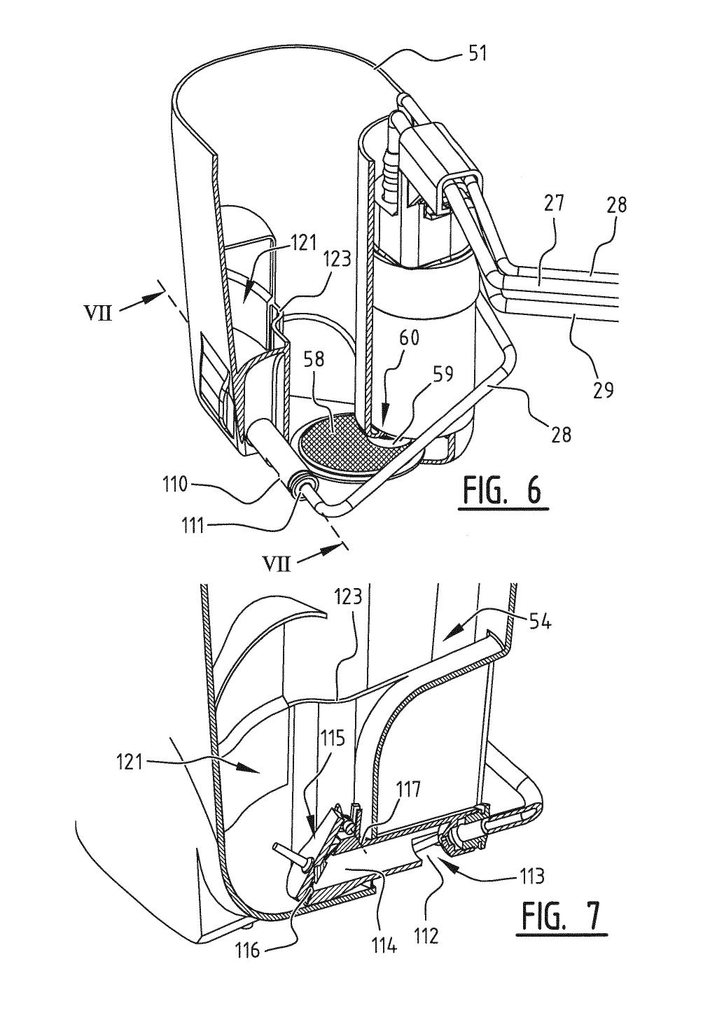

FIG. 6 is a partially cut-away view of a storage bag and fuel pump according to an embodiment;

FIG. 7 is a cross-sectional view along VII-VII in FIG. 6; and

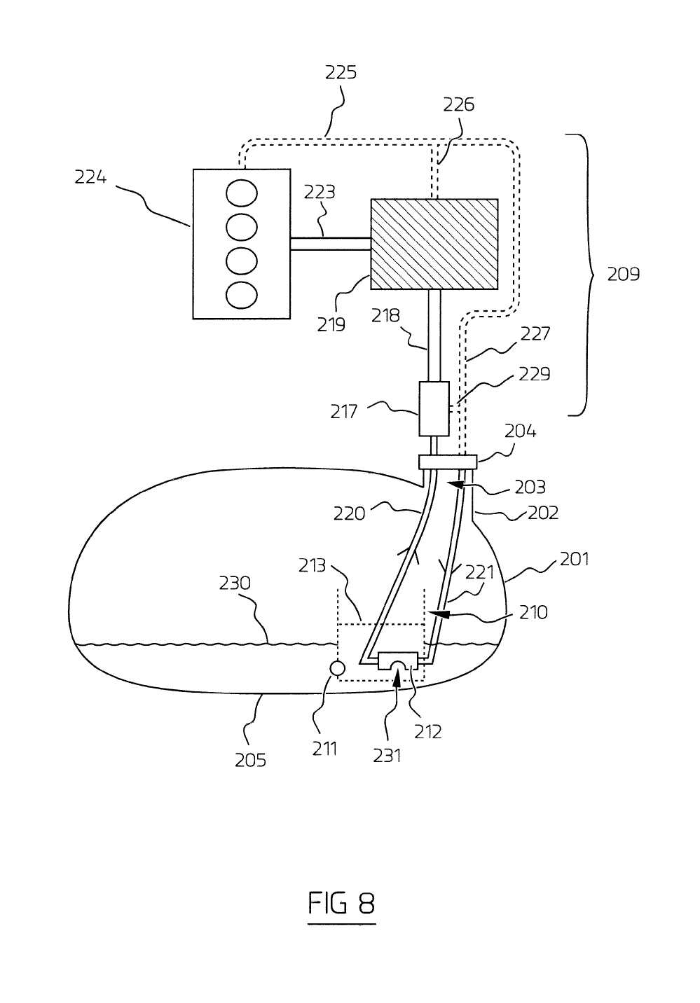

FIG. 8 is a schematically view of a further embodiment.

FIG. 1 shows a schematic perspective view of an assembly 10. The liquefied petroleum gas storage tank or pressure vessel 11 is part of the assembly 10. The LPG storage tank 11 is ring-shaped and can be mounted in a vehicle for personal or professional use at the position of the spare wheel. The storage tank 11 has an opening 12.

Accessory plate or cap 20 is mounted on opening 12 of the tank 11. Opening 12 is shown in more detail in FIGS. 3-5. The accessory plate can provide one or more LPG fuel system functionalities. Cap 20 is shaped such that is can be mounted on the opening 12. Suitable connectors can be used. Opening 12 can have a predetermined size. The invention is not limited to a certain size. Current openings are 48 mm in diameter. The size of the opening limits the products that can be mounted inside the storage tank 11.

Cap 20 is connected to fuel lines 22,23. The fuel lines 22, 23 can be connected to an engine of a vehicle. Fuel line 22 can be a fuel supply line. Fuel line 23 can be a fuel return line connected with the engine for returning fuel to the fuel storage.

FIG. 1 also shows electrical wiring 24 that can be connected to a battery (not shown). Cap 20 can also comprise safety (one-way) valves for shutting off the supply of liquefied petroleum gas from the LPG storage tank 11. Further cap 20 can comprises a fuel inlet (not shown) for refuelling LPG into the LPG storage tank 11.

Schematically illustrated fuel lines 22,23 connect the cap 20 with an engine 40 comprising several cylinders 41. The engine is arranged to use LPG as fuel.

In an embodiment the fuel supply line 22 is connected to an indirect fuel injection system such as a Multipoint Injection system for LPG. Operating pressures are about 8-15 bar.

In an embodiment the fuel supply line 22 is connected to a high pressure pump 30. In an embodiment the fuel supply system is a direct injection fuel supply system.

In an embodiment the engine can be an indirect or a direct injection type engine.

The return line from either a MPI system or a direct injection fuel system is at least 2 bar more than the supply pressure from the storage tank.

Fuel can be fed over fuel line 22 to a common rail 42 for injection in to the cylinders 41. A return 43 is connected to fuel return line 23 to return fuel to the tank.

Clearly other configurations of the fuel supply (and return) system are possible within the scope of the invention. Generally fuel supply (and return) system allows fuel to be transferred between LPG storage tank 11 and engine 40.

Cap 20 is connected by an arm 25 to a float 26. Arm 25 and float 26 extend internally of the LPG storage tank 11 and are arranged to determine the level of fuel in the LPG storage tank 11. A suitable actuator can measure the position of the arm 25 with respect to the cap 20 in order to determine the amount of fuel present in the LPG storage tank. A suitable signal can be provided to the vehicles fuel system.

From cap 20 three connections 27,28,29 extend to a fuel pump 50 and storage bag 51 of assembly 52.

Connection or supply line 27 is a fuel connection allowing the supply of fuel from the fuel pump 50 to the cap 20 (and subsequently the engine). The supply line 27 runs from the fuel pump 50 to the cap 20.

Connection or return line 28 allows the return of fuel from the engine through cap 20. In this embodiment return line 28 is connected to a motive fluid inlet 111 of the jet pump 110.

Connection 29 can surround electrical wiring for supplying current/voltage to the pump 50.

Any of the connections 27-29, but especially connection 29, can be a stiff element arranged to hold the assembly 52 in a certain position. The connection is arranged to mount the assembly 52 near or onto a bottom part of the LPG storage tank 11. This will ensure that the assembly is held near that part of the tank that will collect most fuel under normal circumstances.

Pump 50 comprises a pump house 56. An internal pumping mechanism (not shown) can pump fuel collected in the storage bag 51 into the supply line 27. A pump inlet is formed near a bottom end 57 of the pump 50.

Pump house 56 has a general upright position. Bottom end 57 is positioned on the bottom of the LPG storage tank 11.

Storage bag 51 is connected to the pump 50. A connection 60, shown in FIG. 6, is formed between storage bag 51 and pump 50. An inlet 59 of the pump 50 is connected to a filter device 58 received in the fuel collection volume 54 inside the storage bag 51. The filter device 58 and inlet 59 is positioned on the bottom of the collection volume 54.

Connection 60 could comprise a hinge. Connection 60 allows adapting the respective position of fuel pump 50 with respect to the storage bag 51. The connection 60 is such that the storage bag 51 is biased in a default position, e.g. the position as shown in FIG. 2, with respect to the pump 50.

Storage bag 51 is formed from a deformable material, preferably a memory material, such as a suitable plastic or rubber, such that it can take on a position, e.g. the position as shown in FIG. 2. After deformation, illustrated hereunder with respect to FIG. 3-5, the deformable material of storage bag 51 will assume its default position again.

In the first default position of assembly 52 fuel pump 50 is held adjacent the storage bag 51. Other default positions are possible within the scope of the invention. In an embodiment the pump is received (partially) in the storage bag 51.

In the illustrated preferred embodiment the inlet 59 of fuel pump 50 is connected to the lower, preferably lowest part of the collection volume 54 of storage bag 51. Fuel will be collected at the lowest position as a result of gravity.

FIGS. 3-5 schematically illustrate insertion of assembly 52 by deformation in order to insert the assembly 52 through an opening 12 of a liquefied petroleum gas storage tank 11. From its default position as shown in FIG. 3, in the illustrated embodiment the storage bag 51 is deformed. In an embodiment the storage bag 51 has a minimum circumference that is wider than the inner circumference of the opening 12. In such an embodiment the storage bag 51 can be inserted only by deforming the storage bag. The flexible material allows such deformation.

Generally connection 60 is arranged to allow an insertion position of the assembly 52, wherein (part of) the storage bag 51 is inserted before or after inserting pump 50 through opening 12 into the LPG storage tank 11. Specifically the connection 60 allows insertion of the storage bag before inserting the pump 50. After insertion the assembly 50 will take its default position.

In an embodiment the insertion position is a more elongated position than the default position. The elongated position allows the make use of the length of insertion through opening 12.

FIGS. 6-7 illustrate the storage bag 51. Storage bag 51 is shown partially cut away.

A jet pump 110 has a motive fluid inlet 111. Fuel can enter the jet pump 110 through opening 112 according to arrow 113. Again stiff connection 29 can mount the assembly 52, and accordingly opening 112 near a bottom part of the fuel storage. Opening 112 can thereby collect the last remaining fuel from the LPG storage tank 11.

The motive fluid enters under higher pressure than the pressure in the storage tank and will draw fuel into the jet pump diffuser throat 114 towards valve 115.

Valve 115 forms an entrance to a pre-collection volume 121. Valve 115 can hinge around hinge axis 117. Valve 115 can comprise a rubber seal 116 that can seal of the valve 115.

Jet pump 110 will, if a fluid is injected into the inlet 111, bring fuel into the pre-collection volume 121. A partition wall 123 separates the pre-collection volume 121 from collection volume 54. When the fluid level in pre-collection volume 121 is higher than the partition wall, fuel will overflow the partition wall and enter the collection volume 54. From the collection volume 54 generally the only exit/outlet is formed by the connection to the inlet 59 of fuel pump 50.

If the jet pump is not functioning, e.g. not fluid is injected into inlet 111, the fluid level in the pre-collection volume 121 could drop. However the fuel already present in the collection volume is still held in that volume 54. The fuel is held in collection volume 54 without relying on mechanical elements such as (one way) valves.

FIG. 8 shows another embodiment, wherein the fuel pump 217 is held outside the LPG storage tank 201. The assembly of LPG storage tank 201, storage bag 210 and fuel pump 217 is connected to a fuel supply system 209 for supplying LPG from the storage tank 201 to a schematically represented engine 224.

LPG storage tank 201 is a pressure vessel having an opening 203 formed by a cylindrical tube 202 welded onto the pressure vessel. The circular accessory plate 204 can be connected to the opening 203 providing LPG functionalities. Accessory plates are well known in the LPG fuel systems.

In some examples of the LPG storage tank 201 the storage bag 210 is received and mounted onto or near the bottom 205 of the LPG storage tank 205. The storage bag 210 is shown in dotted lines to indicate that its presence is not necessary in the embodiment of FIG. 8. The storage bag 210 is arranged to accommodate a buffer volume of liquid LPG.

In the LPG storage tank 201 the liquid LPG level 230 is shown.

The storage bag 210 can be connected to the bottom or can be held in position using a suspension connected to the accessory plate 204. The suspension can be a rigid arm extending from the plate 204 inwardly into the storage tank 201.

Although a storage bag 210 is shown having similar features as the storage bag of other embodiments, clearly the storage bag can be embodied differently.

The storage bag 210 has as a supply unit 211. The supply unit 211 is shown schematically on a side of the storage bag. The supply unit 211 can be formed by a jet pump, similar to earlier embodiments, or can be formed by a one-way valve that allows entry of liquid LPG into the collection volume and prevents leakage. The liquid LPG propelled by a jet pump into the storage bag can overflow a separating wall 213 to enter the collection volume.

A (further) jet pump 212 is arranged to propel liquid LPG into a supply line 220. The LPG supply line 220 forms a connection between accessory plate 204 and the jet pump 212. Liquid LPG supply line 220 comprises the jet pump 212. A suction line 231 of the jet pump 212 is connected to the collection volume of the storage bag 210 or is held close or on the bottom 205 of the LPG storage tank 201. The LPG supply line 220 provides liquid LPG from the storage bag 210 to the fuel system 209.

Jet pump 212 is also connected over a supply line 221 with the accessory plate 204. This supply line 221 allows providing the jet pump 212 with LPG as motive fluid. The supply line 221 is connected to the motive fluid inlet of the jet pump 212. Supply line 221 provides LPG from outside the LPG storage tank 201 to the jet pump 212.

In the shown embodiment the fuel pump 217 is located outside the LPG storage tank 210. The jet pump 212 can provide pressure, in the order of 0.05 bar or somewhat more, which is enough to feed an external LPG pump 217.

The connection between jet pump 212, and in some examples the storage bag 210, and fuel pump 217, here comprising at least the supply line 220 and supply line 221, allows mounting the jet pump 212, and in some examples storage bag 210, inside the LPG storage tank 201 and mounting the fuel pump 217 outside the LPG storage tank 210.

Clearly the LPG fuel pump 217 does not need to be provided on an outside surface of the accessory plate. In other embodiment the LPG fuel pump 217 is provided on an inside surface and is held internal in the LPG storage tank 201. In yet another embodiment the LPG fuel pump 217 is held in the opening of the torus shaped LPG storage tank, in an embodiment at a height similar to a height when the LPG fuel pump would have been held inside the LPG storage tank 201.

LPG from the LPG storage tank 201 is pumped by LPG fuel pump 217 into the fuel system 209. The fuel system 209 can comprise several features, represented by ‘black box’ 219. The black box 219 can comprise e.g. a high pressure pump or or connections with a further fuel storage for providing a bi-fuel system. From the black box 219 fuel is supplied over line 223 to engine 224.

A return fuel line 226 from the black box 219 and/or a return fuel line 225 from the engine 224 can be provided for return liquid or evaporated LPG to the storage tank 201. Return line 227 (dotted line) can further be connected to a return line 229 from fuel pump 217. In this embodiment the return line 227 is connected to the supply line 221 connected to the jet pump 212 and provides the motive flow for the jet pump 212. In another embodiment fuel is pump directly from the fuel pump 217 to the jet pump 212.

Although the figures show preferred embodiments, the scope of the claims is not limited to the illustrated embodiments. The skilled man will be able to apply the invention in different ways.

1. Assembly for buffering a liquefied petroleum gas (LPG) in a liquefied petroleum gas storage tank having an opening, the assembly comprising:
a storage bag for temporarily accommodating the liquefied petroleum gas, having a fuel collection volume and a supply unit for allowing liquefied petroleum gas from the LPG storage tank to enter into the fuel collection volume;
a fuel pump having a pump housing and an inlet; and
a connection between the storage bag and the fuel pump arranged to connect the inlet to the fuel collection volume;
wherein the connection is arranged to allow insertion of the storage bag and fuel pump the one after the other through the opening of the liquefied petroleum gas storage tank.

2. Assembly according to claim 1, wherein the connection or the storage bag has a deformed state that allows insertion of the storage bag and fuel pump the one after the other through the opening of the liquefied petroleum gas storage tank.

3. Assembly according to claim 1, wherein the connection between the fuel pump and storage bag or the storage bag has a default state, wherein the connection or storage bag is biased toward the default state to hold the storage bag in a default position with respect to the fuel pump, different from the position in the deformed state.

4. Assembly according to claim 3, wherein the fuel pump and storage bag extend adjacently in the default state and wherein the assembly in the deformed state during insertion through an opening of the LPG storage tank, wherein the fuel pump and storage bag extend generally in line with each other.

5. Assembly according to claim 1, wherein the connection between storage bag and fuel pump comprises a hinge.

6. Assembly according to claim 1, wherein the assembly further comprises a cap to be mounted in the opening of the liquefied petroleum gas storage tank, wherein the cap is connected to the fuel pump or the storage bag such that the storage bag is mounted on or near a bottom of the liquefied petroleum gas storage tank.

7. Assembly according to claim 6, wherein a fuel supply line and at least one electric line connects the fuel pump and cap.

8. Assembly according to claim 1, wherein the storage bag is formed from deformable memory material, wherein the storage bag has a default shape and is deformed to be fed through the opening, wherein the default shape is larger than the opening.

9. Assembly according to claim 1, wherein the supply unit comprises a pump and a fuel pre-collection volume having a liquefied petroleum gas inlet, wherein a partition wall is arranged to allow overflowing of liquefied petroleum gas from the pre-collection volume into the collection volume.

10. Assembly according to claim 1, wherein the supply unit comprises a jet pump.

11. Assembly according to claim 10, wherein a fuel line connects the cap with a motive fluid inlet of the jet pump.

12. Assembly for buffering a liquefied petroleum gas (LPG) in a liquefied petroleum gas storage tank having an opening, the assembly comprising:
a storage bag for temporarily accommodating the liquefied petroleum gas, having a fuel collection volume and a supply unit for allowing liquefied petroleum gas from the storage to enter into the fuel collection volume;
a fuel pump having an inlet; and
a connection between the fuel pump and the storage bag arranged to connect the inlet to the fuel collection volume;
wherein the connection is arranged to allow mounting the storage bag in the liquefied petroleum gas storage tank and mounting the fuel pump outside the liquefied petroleum gas storage tank.

13. Assembly according to claim 12, wherein the supply unit comprises a jet pump.

14. Assembly according to claim 13, wherein a motive fluid inlet of the jet pump is connected to a LPG jet pump supply line in the connection, the jet pump supply line connected to a fuel line external from the LPG storage tank.

15. Assembly according to claim 1, further comprising a liquefied petroleum gas storage tank.

16. Assembly for supplying a liquefied petroleum gas (LPG) to an LPG fuel system, the assembly comprising:
a liquefied petroleum gas storage tank having an opening;
a jet pump;
a LPG fuel pump having an inlet; and
a connection between the fuel pump and the jet pump arranged to connect the inlet to the jet pump;
wherein the jet pump is arranged in the liquefied petroleum gas storage tank and the fuel pump is mounted outside the liquefied petroleum gas storage tank.

17. Assembly according to claim 16, wherein the assembly further comprises a storage bag for temporarily accommodating the liquefied petroleum gas, having a fuel collection volume and a supply unit for allowing liquefied petroleum gas from the storage to enter into the fuel collection volume.

18. Assembly according to claim 16, wherein a LPG supply line from external from the LPG storage tank is connected to a motive fluid inlet of the jet pump for providing the motive fluid to the jet pump.

19. Assembly according to claim 16, wherein the connection or the LPG supply line is arranged to hold the jet pump and/or storage bag near or onto a bottom of the LPG storage tank.

20. Fuel supply system for liquefied petroleum gas to an engine, connected to an assembly according to claim 1, wherein a fuel supply line from the fuel pump can be connected to the engine.

21. Fuel supply system according to claim 20, wherein a fuel return line from the engine is connected to a motive fluid inlet of a jet pump that is a part of the supply unit.

22. Storage bag for temporarily accommodating a liquefied petroleum gas for a liquefied petroleum gas storage tank, the storage bag having a fuel collection volume and a supply unit for feeding fuel to the fuel collection volume from the liquefied petroleum gas storage, wherein the supply unit comprises a jet pump.

23. Storage bag according to claim 22, wherein the storage bag is connected to an inlet of a fuel pump mounted outside the liquefied petroleum gas storage tank.

24. Storage bag for temporarily accommodating a liquefied petroleum gas for a liquefied petroleum gas storage tank, the storage bag having a fuel collection volume connectable with a fuel pump inlet and a supply unit for feeding fuel to the fuel collection volume from the liquefied petroleum gas storage tank, wherein the supply unit comprises fuel pre-collection volume having a liquefied petroleum gas inlet, wherein a partition wall is arranged to allow overflowing of liquefied petroleum gas from the pre-collection volume to the collection volume.

25. Storage bag according to claim 24, wherein the liquefied petroleum gas inlet comprises a jet pump.

26. Storage bag according to claim 22, wherein the storage bag is formed from a deformable memory material.

27. Storage bag according to claim 22, wherein the storage bag has a temporary, size-reduced condition, an outer diameter of the storage bag then being less than a predetermined size, and a second, operative condition, the storage bag having a volume, with an outer diameter of greater than the predetermined size.

28. Vehicle comprising an engine and having an assembly according to claim 1.

29. Method of mounting a LPG storage bag for buffering liquid LPG and LPG fuel pump in a LPG storage tank the method comprising feeding the storage bag and fuel pump the one after the other through an opening of the LPG storage tank.

30. Method according to claim 29, wherein the method comprises deforming a connection between the LPG storage bag and LPG fuel pump during the insertion.

31. Method according to claim 30, wherein the method further comprises the connection biasing, preferably resiliently, the LPG storage bag and LPG fuel pump in a default position.

32. Assembly according to claim 12, further comprising a liquefied petroleum gas storage tank.

33. Fuel supply system for liquefied petroleum gas to an engine, connected to an assembly according to claim 12, wherein a fuel supply line from the fuel pump can be connected to the engine.

34. Fuel supply system according to claim 33, wherein a fuel return line from the engine is connected to a motive fluid inlet of a jet pump that is a part of the supply unit.

35. Fuel supply system for liquefied petroleum gas to an engine, connected to an assembly according to claim 16, wherein a fuel supply line from the fuel pump can be connected to the engine.

36. Fuel supply system according to claim 35, wherein a fuel return line from the engine is connected to a motive fluid inlet of a jet pump that is a part of the supply unit.

37. Storage bag according to claim 24, wherein the storage bag is formed from a deformable memory material.

38. Storage bag according to claim 24, wherein the storage bag has a temporary, size-reduced condition, an outer diameter of the storage bag then being less than a predetermined size, and a second, operative condition, the storage bag having a volume, with an outer diameter of greater than the predetermined size.

39. Vehicle comprising an engine and having an assembly according to claim 12.

40. Vehicle comprising an engine and having an assembly according to claim 16.

41. Vehicle comprising an engine and having a storage bag according to claim 22.

42. Vehicle comprising an engine and having a storage bag according to claim 24.
